(19) United States
(12) Patent Application Publication
(10) Pub. No.: US 2017/0363907 A1
(43) Pub. Date: Dec. 21, 2017

(54) Display Panel and Display Device

(71) Applicants: BOE Technology Group Co., Ltd., Beijing (CN); Beijing BOE Optoelectronics Technology Co., Ltd., Beijing (CN)

(72) Inventors: Qian Wang, Beijing (CN); Xiaochuan Chen, Beijing (CN); Wenqing Zhao, Beijing (CN); Jian Gao, Beijing (CN); Xiaochen Niu, Beijing (CN)

(73) Assignees: BOE Technology Group Co., Ltd., Beijing (CN); Beijing BOE Optoelectronics Technology Co., Ltd., Beijing (CN)

(21) Appl. No.: 15/537,534

(22) PCT Filed: Nov. 18, 2016
(86) PCT No.: PCT/CN2016/106400

§ 371 Date: Jun. 19, 2017

(30) Foreign Application Priority Data
Jan. 8, 2016 (CN) 201610012168.3

(51) Int. Cl. G02F 1/1335

(52) U.S. Cl. CPC G02F 1/133514; G02F 1/133528; G02F 1/133602

(57) ABSTRACT

A display panel and a display device are provided. The display panel includes: a first substrate, including a plurality of pixel units, each pixel unit including a plurality of sub-pixels with different colors; a second substrate, disposed opposite to the first substrate; and a light splitting film, configured to decompose white light incident thereon into a plurality of monochromatic lights which respectively correspond to the plurality of sub-pixels of each pixel unit in color and respectively project the plurality of monochromatic lights onto the plurality of sub-pixels of each pixel unit.

### TECHNICAL FIELD

Embodiments of the present disclosure relate to a display panel and a display device.

### BACKGROUND

A Thin Film Transistor-Liquid Crystal Display (TFT-LCD) has advantages of low radiation, small size, low energy consumption, etc., and is thus widely applied to electronic products such as a laptop computer, a Personal Digital Assistant (PDA), a flat-screen television or a mobile phone.

The TFT-LCD comprises a display panel and a backlight source; the display panel includes an opposed substrate, an array substrate and a liquid crystal layer disposed between the opposed substrate and the array substrate, and the opposed substrate or the array substrate is provided with a color filter (CF). The color filter is made of resin generally, and, for example, comprises a red color filter, a green color filter and a blue color filter, so as to filter white light emitted by the backlight source. Light rays, consistent with the corresponding color of the color filter, in the white light can be transmitted by the color filter, and light rays, inconsistent with the corresponding color of the color filter, in the white light is absorbed by the color filter. For example, red light in the white backlight is transmitted through the red color filter, green light in the white backlight is transmitted through the green color filter and blue light in the white backlight is transmitted through the blue color filter. It can be seen that for the white light emitted by the backlight source, only a small part of the light can be transmitted through the display panel; as a result, a utilization rate of the light from the backlight is low.

### SUMMARY

According to embodiments of the disclosure, a display panel is provided. The display panel comprises: a first substrate, including a plurality of pixel units, each pixel unit including a plurality of sub-pixels with different colors; a second substrate, disposed opposite to the first substrate; and a light splitting film, configured to decompose white light incident thereon into a plurality of monochromatic lights which respectively correspond to the plurality of sub-pixels of each pixel unit in color and respectively project the plurality of monochromatic lights onto the plurality of sub-pixels of each pixel unit.

For example, the display panel further comprises a wire grating polarizer, and the wire grating polarizer is disposed between the light splitting film and the first substrate or the light splitting film is disposed between the wire grating polarizer and the first substrate.

For example, the light splitting film includes a plurality of light splitting microstructures, and the light splitting microstructures are sin gratings.

For example, the light splitting microstructures are uniformly distributed in the light splitting film.

For example, a placement angle of each light splitting microstructure in the light splitting film meets the following formula group:

$${α}_{q} = α + q \frac{λ}{Λ} cos {θ}_{G} ;$$

$${β}_{q} = β + q \frac{λ}{Λ} sin {θ}_{G} ;$$

$${γ}_{q} = {( 1 - {α}_{q}^{2} - {β}_{q}^{2} )}^{1 / 2} ;$$

where λ is a wavelength of a monochromatic light to be decomposed from an incident light of the light splitting film, Λ is a period of a sine curve corresponding to the sin grating, α is an included angle between the incident light of the light splitting film and an X axis, β is an included angle between the incident light of the light splitting film and a Y axis, α_{q} is an included angle between an emergent light of the light splitting film and the X axis, β_{q} is an included angle between the emergent light of the light splitting film and the Y axis, γ_{q} is an included angle between the emergent light of the light splitting film and a Z axis, θ_{G} is an included angle between the placement angle of the light splitting microstructure in the light splitting film and the X axis, and q is an order of the light splitting microstructure.

For example, a distance from the light splitting microstructure to its corresponding sub-pixel is in direct proportion to a width of the sub-pixel, and a distance from the light splitting film to its corresponding sub-pixels is in direct proportion to a tangential value of an included angle between the light splitting film and an emergent light of the light splitting film.

For example, the distance from the light splitting microstructure to its corresponding sub-pixel meets the following formula:

h=l*tan e
where h is the distance from the light splitting microstructure to its corresponding sub-pixel, l is a width of two sub-pixels in the pixel unit, and e is the included angle between the emergent light of the light splitting film and a plane where the light splitting film is.

For example, the display panel further comprises a liquid crystal layer and an upper polarizer of which an optical axis is perpendicular to that of the wire grating polarizer; the liquid crystal is disposed between the first substrate and the second substrate; and the upper polarizer is disposed on a surface of the second substrate facing away from the first substrate.

For example, the display panel further comprises a liquid crystal layer, and an upper polarizer and a lower polarizer of which optical axes are perpendicular to each other. The liquid crystal layer is disposed between the first substrate and the second substrate. The upper polarizer is disposed on a surface of the second substrate facing away from the first substrate, and the lower polarizer is disposed on a surface of the light splitting film facing away from the first substrate; or the upper polarizer is disposed on the surface of the second substrate facing away from the first substrate, and the lower polarizer is disposed between the light splitting film and the first substrate.

For example, neither the first substrate nor the second substrate is provided with a color filter.

According to the embodiments of the disclosure, a display device is provided. The display device comprises the display panel as described above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a structural schematic view illustrating a display panel provided by embodiments of the present disclosure;

FIG. 2 is a structural schematic view illustrating the display panel having a wire grating polarizer provided by the embodiments of the present disclosure;

FIG. 3 is a schematic view illustrating a sine curve corresponding to a sin grating in the case that light splitting microstructures in a light splitting film are sin gratings provided by the embodiments of the present disclosure;

FIG. 4 is a schematic view illustrating a placement angle of the light splitting microstructure in the light splitting film provided by the embodiments of the present disclosure;

FIG. 5 is a schematic view illustrating a distance from the light splitting microstructures to corresponding sub-pixels provided by the embodiments of the present disclosure; and

FIG. 6 is a structural schematic view illustrating a display device provided by the embodiments of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

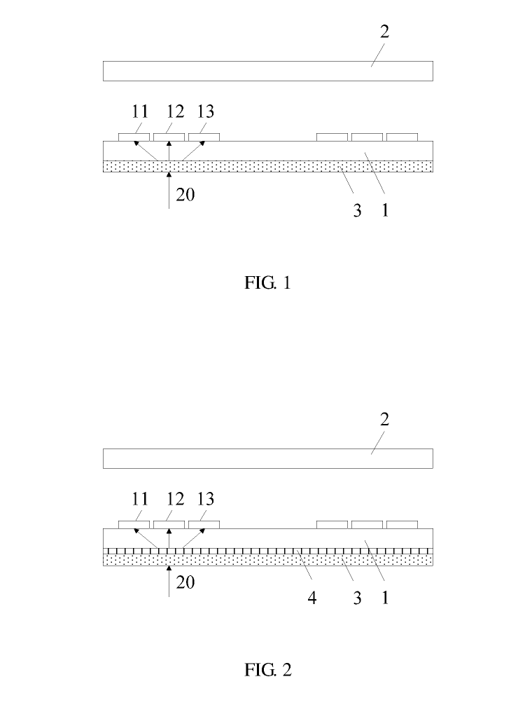

Referring to FIG. 1, embodiments of the present disclosure provide a display panel, and the display device comprises: a first substrate 1, including a plurality of pixel units, each pixel unit including a plurality of sub-pixels with different colors (for example, each pixel unit includes a first sub-pixel 11, a second sub-pixel 12 and a third sub-pixel 13 respectively corresponding to different monochromatic lights); a second substrate 2, disposed opposite to the first substrate 1; and a light splitting film 3. The light splitting film 3 is disposed on a surface of the first substrate 1 facing away from the second substrate 2, the light splitting film 3 is configured to decompose white light 20 incident thereon into a plurality of monochromatic lights which respectively correspond to the plurality of sub-pixels of each pixel unit in color and respectively project the plurality of monochromatic lights onto the plurality of sub-pixels of each pixel unit (for example, the light splitting film 3 is configured to decompose the white light 20 incident thereon into the monochromatic lights which respectively correspond to the first sub-pixel 11, the second sub-pixel 12 and the third sub-pixel 13 in color and respectively project the monochromatic lights onto the first sub-pixel 11, the second sub-pixel 12 and the third sub-pixel 13).

For example, the white light 20 is incident from a surface of the light splitting film 20 facing away from the first substrate 1. For example, the white light 20 is provided by a backlight source.

For example, the first sub-pixel 11, the second sub-pixel 12 and the third sub-pixel 13 are a red sub-pixel, a green sub-pixel and a blue sub-pixel respectively, or sub-pixels of other colors capable of realizing display, which is not limited by the embodiments of the present disclosure. In a case that the first sub-pixel 11, the second sub-pixel 12 and the third sub-pixel 13 are the red sub-pixel, the green sub-pixel and the blue sub-pixel respectively, a first monochromatic light, a second monochromatic light and a third monochromatic light that the light splitting film 3 decomposes from the white light 20 are a red light, a green light and a blue light respectively, and the light splitting film 3 projects the decomposed red light onto the red sub-pixel, the decomposed green light onto the green sub-pixel and the decomposed blue light onto the blue sub-pixel.

In the embodiments of the present disclosure, the light splitting film 3 decomposes the white light 20 incident thereon to obtain the monochromatic lights corresponding to respective sub-pixels (for example, the first sub-pixel 11, the second sub-pixel 12 and the third sub-pixel 13), and correspondingly provides the decomposed monochromatic lights to the sub-pixels, in this way, the white light is fully used, and the case that the light rays in the white light 20 inconsistent with the sub-pixels in color are blocked is avoided, such that loss caused by filtering the white light 20 provided by the backlight source is reduced, and a light utilization rate is improved.

For example, as shown in FIG. 2, the display panel further includes a wire grating polarizer 4, and the wire grating polarizer 4 is disposed between the light splitting film 3 and the first substrate 1. In the case that the wire grating polarizer 4 is adopted, the wire grating polarizer 4 and the light splitting film 3 for example are prepared by adopting a same process apparatus (for example, a same etching apparatus), and a process cost is reduced. In addition, a manufacturing precision of the wire grating polarizer 4 is higher than a polarizer attached by a traditional attachment process, such that the manufacturing precision of the whole display panel is improved. It should be noted that as shown in FIG. 2, the wire grating polarizer 4 is disposed between the light splitting film 3 and the first substrate 1; however, the embodiments of the present disclosure are not limited thereto, the wire grating polarizer 4 for example is disposed on a surface of the light splitting film 3 facing away from the first substrate 1, that is, the light splitting film 3 is disposed between the first substrate 1 and the wire grating polarizer 4.

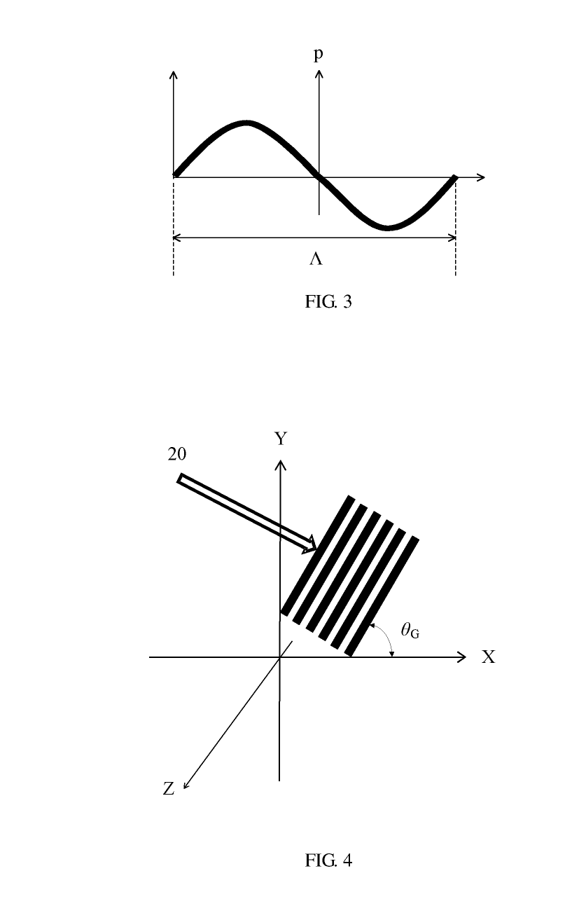

In order to understand the light splitting film 3 more clearly, the light splitting film 3 is described below in detail in combination with FIGS. 3-5.

For example, as shown in FIG. 3, the light splitting film 3 comprises a plurality of light splitting microstructures, and the light splitting microstructures are, for example, sin gratings. Λ is a period of a sine curve corresponding to the sin grating, and a normal P of the sine curve is perpendicular to a plane where the sin grating is. In order to uniformize intensities of the monochromatic lights provided by the light splitting film 3, for example, the plurality of light splitting microstructures are uniformly distributed in the light splitting film 3.

As shown in FIG. 4, a placement angle of the light splitting microstructure in the light splitting film 3 meets the following formulas 1-3:

$$\begin{matrix}{α}_{q} = α + q \frac{λ}{Λ} cos {θ}_{G} & ( 1 ) \\ {β}_{q} = β + q \frac{λ}{Λ} sin {θ}_{G} & ( 2 ) \\ {γ}_{q} = {( 1 - {α}_{q}^{2} - {β}_{q}^{2} )}^{1 / 2} & ( 3 )\end{matrix}$$

Where λ is wavelength of a monochromatic light to be decomposed from incident light of the light splitting film 3 (i.e., a wavelength of a monochromatic light to be decomposed from the incident white light 20, for example, a wavelength of a red light in the incident white light 20, a wavelength of a green light in the incident white light 20, or a wavelength of a blue light in the incident white light 20), Λ is a period of the sine curve of the sin grating, α is an included angle between the incident light of the light splitting film 3 and an X axis, β is an included angle between the incident light of the light splitting film 3 and a Y axis, α_{q} is an included angle between an emergent light of the light splitting film 3 and the X axis, β_{q} is an included angle between the emergent light of the light splitting film 3 and the Y axis, γ_{q} is an included angle between the emergent light of the light splitting film 3 and a Z axis, θ_{G} is an included angle between the placement angle of the light splitting microstructure in the light splitting film 3 and the X axis, and q is an order of the light splitting microstructure. It can be seen from the formulas 1-3 described above that by adjusting the placement angle of the light splitting microstructure, the light having a certain wavelength λ is emergent along a specific direction (determined by α_{q}, β_{q} and γ_{q}), such that the light splitting film 3 has a light splitting function and is capable of projecting separated monochromatic lights onto corresponding sub-pixels.

For example, one monochromatic light beam having one color is separated from the light splitting microstructure having the placement angle θ_{G}, and such monochromatic light beam is projected onto one or more sub-pixels corresponding to the monochromatic light in color. For example, a plurality of monochromatic light beams with the same color are separated from multiple light splitting microstructures having the placement angle θ_{G}, and the plurality of monochromatic light beams with the same color are projected onto the one or more sub-pixels corresponding to the monochromatic light in color.

For example, a distance from the light splitting microstructure to its corresponding sub-pixel is in direct proportion to a width of the sub-pixel, and a distance from the light splitting film 3 to its corresponding sub-pixels is in direct proportion to a tangential value of an included angle between the light splitting film 3 and emergent light of the light splitting film 3. It should be noted that the distance from the light splitting microstructure to the corresponding sub-pixel can be understood as the distance from the light splitting film 3 to a surface of the first substrate 1 facing the second substrate 2.

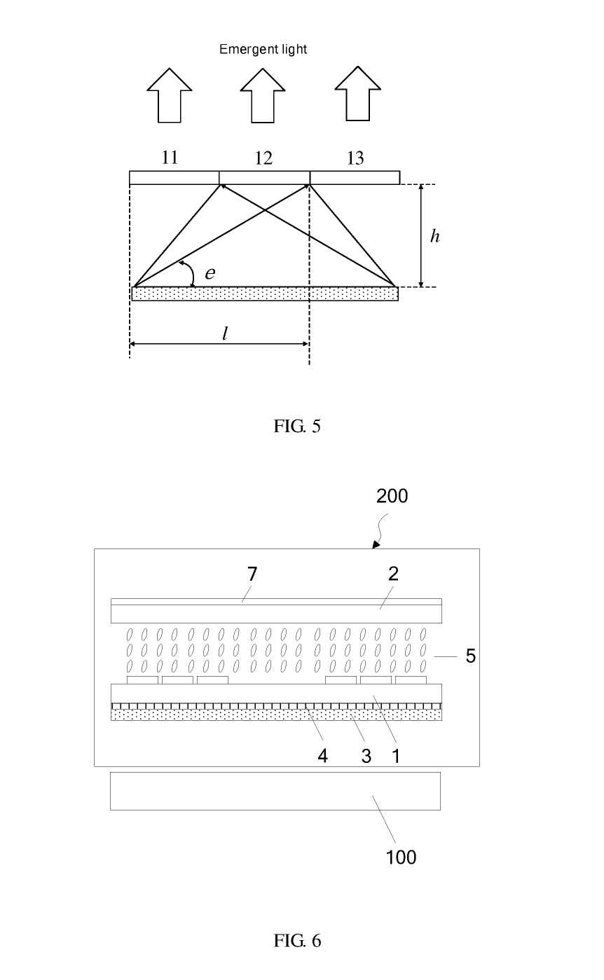

For example, referring to FIG. 5, the distance from the light splitting microstructure to the corresponding sub-pixel meets the following formula (4):

h=l*tan e (4)

Where h is the distance from the light splitting microstructure to the corresponding sub-pixel, l is a width of two sub-pixels, and e is an included angle between the emergent light of the light splitting film 3 and a plane where the light splitting film 3 is.

For example, as shown in FIG. 6, the display panel further comprises a liquid crystal layer 5 and an upper polarizer 7 of which an optical axis is perpendicular to that of the wire grating polarizer 4; the liquid crystal 5 layer is disposed between the first substrate 1 and the second substrate 2; and the upper polarizer 7 is disposed on a surface of the second substrate 2 facing away from the first substrate 1. It should be noted that as shown in the drawing, if the wire grating polarizer 4 is not disposed, then a lower polarizer of which an optical axis is perpendicular to that of the upper polarizer 7 is required to be disposed on the surface of the first substrate 1 facing away from the second substrate 2, and the lower polarizer is disposed on the surface of the light splitting film facing away from the first substrate or the lower polarizer is disposed between the light splitting film and the first substrate.

For example, the first substrate 1 is an array substrate, the second substrate 2 is an opposed substrate, and the first substrate 1 and the second substrate 2 is provided with a color filter or is not be provided with the color filter. In order to obtain a higher light transmittance, for example, neither of the first substrate 1 nor the second substrate 2 is provided with the color filter. In the embodiments of the present disclosure, the monochromatic lights obtained by the light splitting film 3 decomposing the white light provided by the backlight source unnecessarily pass through the color filter, and thus the light transmittance is improved.

As shown in FIG. 6, the embodiments of the present disclosure further provide a display device, comprising a backlight module 100 and the display panel 200 provided by the embodiments described above.

The foregoing embodiments merely are exemplary embodiments of the disclosure, and not intended to define the scope of the disclosure, and the scope of the disclosure is determined by the appended claims.

The application claims priority of Chinese Patent Application No. 201610012168.3 filed on Jan. 8, 2016, the disclosure of which is incorporated herein by reference in its entirety as part of the present application.

1. A display panel, comprising:
a first substrate, including a plurality of pixel units, each pixel unit including a plurality of sub-pixels with different colors;
a second substrate, disposed opposite to the first substrate; and
a light splitting film, configured to decompose white light incident thereon into a plurality of monochromatic lights which respectively correspond to the plurality of sub-pixels of each pixel unit in color and respectively project the plurality of monochromatic lights onto the plurality of sub-pixels of each pixel unit.

2. The display panel according to claim 1, further comprising a wire grating polarizer, and the wire grating polarizer is disposed between the light splitting film and the first substrate or the light splitting film is disposed between the wire grating polarizer and the first substrate.

3. The display panel according to claim 1, wherein the light splitting film includes a plurality of light splitting microstructures, and the light splitting microstructures are sin gratings.

4. The display panel according to claim 3, wherein the light splitting microstructures are uniformly distributed in the light splitting film.

5. The display panel according to claim 3, wherein a placement angle of each light splitting microstructure in the light splitting film meets the following formula group:
$${α}_{q} = α + q \frac{λ}{Λ} cos {θ}_{G} ;$$
$${β}_{q} = β + q \frac{λ}{Λ} sin {θ}_{G} ;$$
$${γ}_{q} = {( 1 - {α}_{q}^{2} - {β}_{q}^{2} )}^{1 / 2} ;$$
where λ is a wavelength of a monochromatic light to be decomposed from an incident light of the light splitting film, Λ is a period of a sine curve corresponding to the sin grating, α is an included angle between the incident light of the light splitting film and an X axis, β is an included angle between the incident light of the light splitting film and a Y axis, α_{q} is an included angle between an emergent light of the light splitting film and the X axis, β_{q} is an included angle between the emergent light of the light splitting film and the Y axis, γ_{q} is an included angle between the emergent light of the light splitting film and a Z axis, θ_{G} is an included angle between the placement angle of the light splitting microstructure in the light splitting film and the X axis, and q is an order of the light splitting microstructure.

6. The display panel according to claim 3, wherein a distance from the light splitting microstructure to its corresponding sub-pixel is in direct proportion to a width of the sub-pixel, and a distance from the light splitting film to its corresponding sub-pixels is in direct proportion to a tangential value of an included angle between the light splitting film and an emergent light of the light splitting film.

7. The display panel according to claim 6, wherein the distance from the light splitting microstructure to its corresponding sub-pixel meets the following formula:
h=l*tan e
where h is the distance from the light splitting microstructure to its corresponding sub-pixel, l is a width of two sub-pixels in the pixel unit, and e is the included angle between the emergent light of the light splitting film and a plane where the light splitting film is.

8. The display panel according to claim 2, further comprising a liquid crystal layer and an upper polarizer of which an optical axis is perpendicular to that of the wire grating polarizer;
the liquid crystal is disposed between the first substrate and the second substrate; and
the upper polarizer is disposed on a surface of the second substrate facing away from the first substrate.

9. The display panel according to claim 1, further comprising a liquid crystal layer, and an upper polarizer and a lower polarizer of which optical axes are perpendicular to each other;
the liquid crystal layer is disposed between the first substrate and the second substrate; and
the upper polarizer is disposed on a surface of the second substrate facing away from the first substrate, and the lower polarizer is disposed on a surface of the light splitting film facing away from the first substrate.

10. The display panel according to claim 1, wherein neither the first substrate nor the second substrate is provided with a color filter.

11. A display device, comprising
a display panel, wherein the display panel comprises:
a first substrate, including a plurality of pixel units, each pixel unit including a plurality of sub-pixels with different colors;
a second substrate, disposed opposite to the first substrate; and
a light splitting film, configured to decompose white light incident thereon into a plurality of monochromatic lights which respectively correspond to the plurality of sub-pixels of each pixel unit in color and respectively project the plurality of monochromatic lights onto the plurality of sub-pixels of each pixel unit.

12. The display panel according to claim 1, further comprising a liquid crystal layer, and an upper polarizer and a lower polarizer of which optical axes are perpendicular to each other;
the liquid crystal layer is disposed between the first substrate and the second substrate; and
the upper polarizer is disposed on the surface of the second substrate facing away from the first substrate, and the lower polarizer is disposed between the light splitting film and the first substrate.

13. The display device according to claim 11, wherein the display panel further comprises a wire grating polarizer, and the wire grating polarizer is disposed between the light splitting film and the first substrate or the light splitting film is disposed between the wire grating polarizer and the first substrate.

14. The display device according to claim 11, wherein the light splitting film includes a plurality of light splitting microstructures and the light splitting microstructures are sin gratings.

15. The display device according to claim 14, wherein the light splitting microstructures are uniformly distributed in the light splitting film.

16. The display device according to claim 14, wherein a placement angle of each light splitting microstructure in the light splitting film meets the following formula group:
$${α}_{q} = α + q \frac{λ}{Λ} cos {θ}_{G} ;$$
$${β}_{q} = β + q \frac{λ}{Λ} sin {θ}_{G} ;$$
$${γ}_{q} = {( 1 - {α}_{q}^{2} - {β}_{q}^{2} )}^{1 / 2} ;$$
where λ is a wavelength of a monochromatic light to be decomposed from an incident light of the light splitting film, Λ is a period of a sine curve corresponding to the sin grating, α is an included angle between the incident light of the light splitting film and an X axis, β is an included angle between the incident light of the light splitting film and a Y axis, α_{q} an included angle between an emergent light of the light splitting film and the X axis, β_{q} is an included angle between the emergent light of the light splitting film and the Y axis, γ_{q} is an included angle between the emergent light of the light splitting film and a Z axis, θ_{G} is an included angle between the placement angle of the light splitting microstructure in the light splitting film and the X axis, and q is an order of the light splitting microstructure.

17. The display device according to claim 14, wherein a distance from the light splitting microstructure to its corresponding sub-pixel is in direct proportion to a width of the sub-pixel, and a distance from the light splitting film to its corresponding sub-pixels is in direct proportion to a tangential value of an included angle between the light splitting film and an emergent light of the light splitting film.

18. The display device according to claim 17, wherein the distance from the light splitting microstructure to its corresponding sub-pixel meets the following formula:
h=l*tan e
where h is the distance from the light splitting microstructure to its corresponding sub-pixel, l is a width of two sub-pixels in the pixel unit, and e is the included angle between the emergent light of the light splitting film and a plane where the light splitting film is.

19. The display device according to claim 13, wherein the display panel further comprises a liquid crystal layer and an upper polarizer of which an optical axis is perpendicular to that of the wire grating polarizer;
the liquid crystal is disposed between the first substrate and the second substrate; and
the upper polarizer is disposed on a surface of the second substrate facing away from the first substrate.

20. The display device according to claim 11, wherein neither the first substrate nor the second substrate is provided with a color filter.
